(19) United States
(12) Patent Application Publication
(10) Pub. No.: US 2023/0353354 A1
(43) Pub. Date: Nov. 2, 2023

(54) TECHNIQUES FOR CONFIGURING A NETWORK MANAGEMENT CARD

(71) Applicant: SCHNEIDER ELECTRIC IT CORPORATION, Foxboro, MA (US)

(72) Inventors: Alan Jackson, Galway (IE); Tomasz Kazimierz Motyl, Kilmaley (IE)

(21) Appl. No.: 18/141,794

(22) Filed: May 1, 2023

Related U.S. Application Data
(60) Provisional application No. 63/336,514, filed on Apr. 29, 2022.

(51) Int. Cl. H04L 9/08; H04L 9/32

(52) U.S. Cl. CPC H04L 9/088; H04L 9/3263

(57) ABSTRACT

A computer program product is provided according to some embodiments. The computer program product includes a non-transitory computer-readable storage medium storing a set of instructions, which, when executed by a computing device, causes the computing device to configure a network management card to be able to perform an authentication and authorization process by: (a) outputting a set of data input pages in an order, wherein the set of data input pages is configured to receive: (1) information identifying a first certificate from a certifying authority, (2) information identifying a private key, (3) a passphrase associated with the private key, and (4) information identifying a second certificate from a user; (b) permitting receiving information on pages of the set out of the order; and (c) in response to the user completing a last page of the set, applying changes inputted by the user via the set of data input pages to configure the network management card to be able to perform the authentication and authorization process.

### CROSS REFERENCE TO RELATED APPLICATION

This Patent application claims priority to U.S. Provisional Patent Application No. 63/336,514 filed on Apr. 29, 2022, entitled, “TECHNIQUES FOR CONFIGURING A NETWORK MANAGEMENT CARD”, the contents and teachings of which are hereby incorporated herein by reference in their entirety.

### BACKGROUND

Universal Power Supply (UPS) units provide a backup source of power to electrical equipment in the event of a power failure. Some UPS units may be configurable with a Network Management Card (NMC) that allows users to manage the UPS unit over a network. Typically, an NMC must be configured with certificates and/or keys in order to be able to undergo authentication and authorization to access the network. This authentication and authorization process may be done using the Extensible Authentication Protocol over Local Area Networks (EAPoL).

### SUMMARY

Unfortunately, configuring an NMC to be able to perform the authentication and authorization process with the use of EAPoL may be a complicated task. For example, such configuration typically requires that various credentials be uploaded in a particular order, failing which, the configuration fails.

Thus, it would be desirable to implement a configuration tool that allows a user to configure the NMC, in a flexible manner, for it to be able to perform the authentication and authorization process using EAPoL. This may be accomplished by providing the user with a set of configuration pages in an order, while also permitting the user to skip input for particular configuration pages for which information has already been entered. In some embodiments, the user may also be permitted to navigate back to previously presented configuration pages to enter information out of order. Final validation and submission of the credentials may be done once the user is ready to submit all credentials. In addition, previously entered credentials, may be retained from a previous configuration attempt, so that the user need not enter all credentials unless there is a change to those credentials.

A computer program product is provided according to some embodiments. The computer program product includes a non-transitory computer-readable storage medium storing a set of instructions, which, when executed by a computing device, causes the computing device to configure a network management card to be able to perform an authentication and authorization process by: (a) outputting a set of data input pages in an order, wherein the set of data input pages is configured to receive: (1) information identifying a first certificate from a certifying authority, (2) information identifying a private key, (3) a passphrase associated with the private key, and (4) information identifying a second certificate from a user; (b) permitting receiving information on pages of the set out of the order; and (c) in response to the user completing a last page of the set, applying changes inputted by the user via the set of data input pages to configure the network management card to be able to perform the authentication and authorization process.

In some embodiments, outputting the set of data input pages in the order includes: (I) causing a first data input page to be displayed to the user, the first data input page being configured to receive the information identifying the first certificate from the certifying authority; (II) causing a second data input page to be displayed to the user, the second data input page being configured to receive the information identifying the private key; (III) causing a third data input page to be displayed to the user, the third data input page being configured to receive the passphrase associated with the private key; and (IV) causing a fourth data input page to be displayed to the user, the fourth data input page being configured to receive the information identifying the second certificate from the user.

In some embodiments, permitting receiving information on pages of the set out of the order includes: (I) allowing the user to skip input on any of the data input pages; and (II) allowing the user to return to any previously displayed data input page.

In some embodiments, applying changes inputted by the user via the set of data input pages in configuration of the network management card to be able to perform the authentication and authorization process includes requesting authentication from a remote authentication device with reference to the first certificate, the private key, and the second certificate. In some embodiments, the instructions, when executed by the computing device, further cause the computing device to, prior to applying the changes inputted by the user, validate the changes inputted by the user.

In some embodiments, the instructions, when executed by the computing device, further cause the computing device to, in response to failure to validate the changes inputted by the user and prior to applying the changes inputted by the user: (A) inform the user what errors led to the failure to validate the changes; and (B) output one or more pages of the set of data input pages again in the order.

In some embodiments, validating the changes inputted by the user includes: (A) confirming that a valid first certificate from the certifying authority has either been received from a remote user device or is already stored on the computing device; (B) confirming, by the network management card, that a valid private key has either been received from the remote user device or is already stored on the computing device; and (C) confirming, by the network management card, that a valid second certificate from the user has either been received from the remote user device or is already stored on the computing device. In some embodiments, validating the changes inputted by the user further includes (D) confirming that a valid passphrase associated with the private key has either been received from the remote user device or is already stored on the computing device.

In some embodiments, validating the changes inputted by the user includes: (A) confirming that the first certificate and second certificate are both formatted according to a first format consistent with a standard used for certificates; and (B) confirming that the private key is formatted according to a second format consistent with a standard used for keys.

In some embodiments, requesting authentication from the remote authentication device is further performed with reference to the passphrase associated with the private key.

In some embodiments, the computing device on which the computer program product executes is the network management card. In other embodiments, the computing device on which the computer program product executes is a separate web server external to the network management card.

An apparatus for remotely configuring a network management card to be able to perform an authentication and authorization process is provided according to some embodiments. The apparatus includes: (i) a network interface configured to communicate with a user device over a network; and (ii) processing circuitry configured to: (a) output a set of data input pages to the user device over the network in an order, wherein the set of data input pages is configured to receive: (1) information identifying a first certificate from a certifying authority, (2) information identifying a private key, (3) a passphrase associated with the private key, and (4) information identifying a second certificate from a user; (b) permit receiving information on pages of the set out of the order; and (c) in response to the user completing a last page of the set, applying changes inputted by the user via the set of data input pages to configure the network management card to be able to perform the authentication and authorization process.

In some embodiments, outputting the set of data input pages in the order includes: (I) causing a first data input page to be displayed to the user, the first data input page being configured to receive, at the user device, the information identifying the first certificate from the certifying authority; (II) causing a second data input page to be displayed to the user, the second data input page being configured to receive, at the user device, the information identifying the private key; (III) causing a third data input page to be displayed to the user, the third data input page being configured to receive, at the user device, the passphrase associated with the private key; and (IV) causing a fourth data input page to be displayed to the user, the fourth data input page being configured to receive, at the user device, the information identifying the second certificate from the user.

In some embodiments, permitting receiving information on pages of the set out of the order includes: (I) allowing the user to skip input on any of the data input pages; and (II) allowing the user to return to any previously displayed data input page.

In some embodiments, applying changes inputted by the user via the set of data input pages in configuration of the network management card to be able to perform the authentication and authorization process includes requesting authentication from a remote authentication device with reference to the first certificate, the private key, and the second certificate.

In some embodiments, the processing circuitry is further configured to, prior to applying the changes inputted by the user, validate the changes inputted by the user.

In some embodiments, the processing circuitry is further configured to, in response to failure to validate the changes inputted by the user and prior to applying the changes inputted by the user: (A) inform the user what errors led to the failure to validate the changes; and (B) output one or more pages of the set of data input pages again in the order.

In some embodiments, validating the changes inputted by the user includes: (A) confirming that a valid first certificate from the certifying authority has either been received from the user device or is already stored on the apparatus; (B) confirming, by the network management card, that a valid private key has either been received from the user device or is already stored on the apparatus; and (C) confirming, by the network management card, that a valid second certificate from the user has either been received from the user device or is already stored on the apparatus. In some embodiments, validating the changes inputted by the user further includes (D) confirming that a valid passphrase associated with the private key has either been received from the user device or is already stored on the apparatus.

In some embodiments, validating the changes inputted by the user includes: (A) confirming that the first certificate and second certificate are both formatted according to a first format consistent with a standard used for certificates; and (B) confirming that the private key is formatted according to a second format consistent with a standard used for keys.

In some embodiments, requesting authentication from the remote authentication device is further performed with reference to the passphrase associated with the private key.

In some embodiments, the apparatus is the network management card. In other embodiments, the apparatus is a separate web server external to the network management card.

A method performed by a computing device for remotely configuring a network management card to be able to perform an authentication and authorization process is provided according to some embodiments. The method includes (a) outputting a set of data input pages in an order, wherein the set of data input pages is configured to receive: (1) information identifying a first certificate from a certifying authority, (2) information identifying a private key, (3) a passphrase associated with the private key, and (4) information identifying a second certificate from a user; (b) permitting receiving information on pages of the set out of the order; and (c) in response to the user completing a last page of the set, applying changes inputted by the user via the set of data input pages to configure the network management card to be able to perform the authentication and authorization process.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system, apparatus, computer program product, and associated data structures for use in connection with one or more embodiments.

FIG. 2 illustrates an example configuration page for use in connection with one or more embodiments.

FIG. 3 illustrates an example configuration page for use in connection with one or more embodiments.

FIGS. 4A-4B illustrates alternative example configuration pages for use in connection with one or more embodiments.

FIG. 5 illustrates an example configuration page for use in connection with one or more embodiments.

FIG. 6 illustrates an example method in accordance with one or more embodiments.

### DETAILED DESCRIPTION

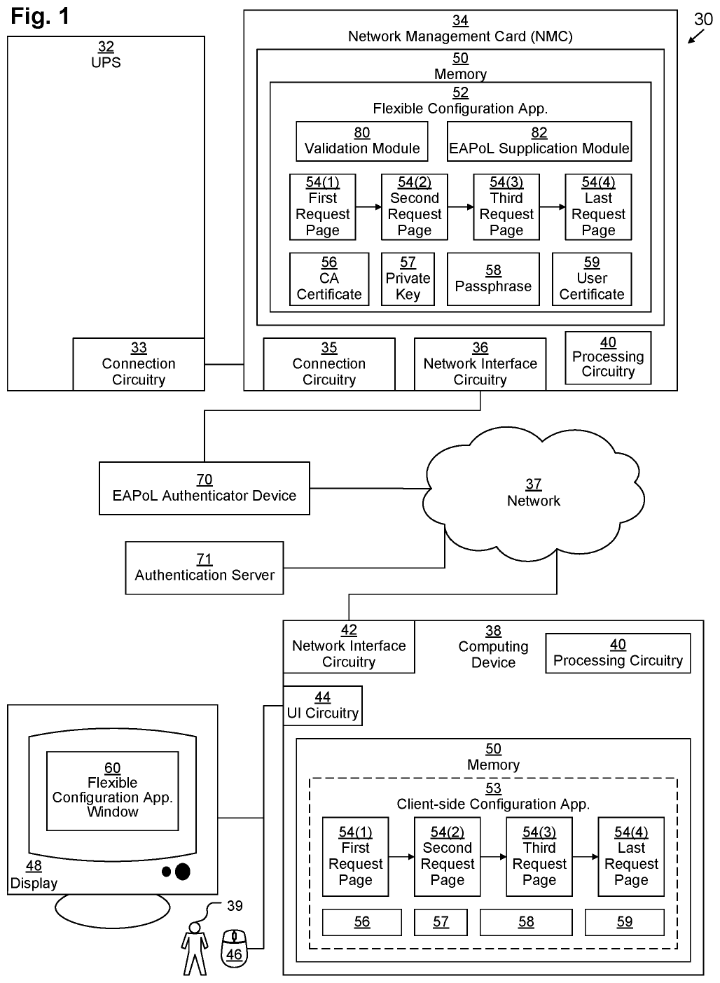

FIG. 1 depicts an example system 30 for use in connection with various embodiments described herein. System 30 includes a Universal Power Supply (UPS) unit 32, a Network Management Card (NMC) 34, a computing device 38, an Extensible Authentication Protocol over Local Area Networks (EAPoL) authenticator device 70 connected to a network 37, and an authentication server 71. In some embodiments, system 30 may also include an external web server (not depicted).

UPS 32 can provide backup power to one or more pieces of electrical equipment. As depicted, UPS 32 includes connection circuitry 33 that allows the UPS 32 to be connected to an external NMC 34 via connection circuitry 35 of the NMC 34. In another embodiment, NMC 34 may be an expansion card that installs internally within UPS 32 via an expansion port.

NMC 34 includes network interface circuitry 36 for connecting to network 37 via EAPoL authenticator device 70. Network interface circuitry 36 may include one or more Ethernet cards, cellular modems, Fibre Channel (FC) adapters, InfiniBand adapters, wireless networking adapters (e.g., Wi-Fi), and/or other devices for connecting to a network, such as, for example, a LAN, WAN, SAN, the Internet, a wireless communication network, a virtual network, a fabric of interconnected switches, etc. In some embodiments (as depicted), NMC 34 may also include processing circuitry 40 and memory 50.

Computing device 38 may be any kind of computing device, such as, for example, a personal computer, laptop, workstation, server, enterprise server, tablet, smartphone, etc. Computing device 38 includes processing circuitry 40, network interface circuitry 42, user interface (UI) circuitry 44, and memory 50. Computing device 38 may also include various additional features as is well-known in the art, such as, for example, user interface circuitry, interconnection buses, etc. Computing device 38 is operated by a user 39 to connect to NMC 34 via network 37 and EAPoL authenticator device 70. In some embodiments, instead of computing device 38 connecting to EAPoL authenticator device 70 via network 37, computing device 38 may connect directly to EAPoL authenticator device 70 through a local or direct connection, such as, for example, over USB. In some embodiments, instead of computing device 38 connecting to NMC 34 via EAPoL authenticator device 70, computing device 38 connects to an external web server (not depicted), e.g., over network 37 to configure the NMC 34 for authentication.

UI circuitry 44 may include any circuitry needed to communicate with and connect to one or more user input devices 46 and display screens 48. UI circuitry 46 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 48 may be any kind of display, including, for example, a CRT, LCD screen, LED screen, etc. Input device 46 may include a keyboard, keypad, mouse, trackpad, trackball, pointing stick, joystick, touchscreen (e.g., embedded within display screen 48), microphone/voice controller, etc. In some embodiments, instead of being external to computing device 38, the input device 46 and/or display screen 48 may be embedded within the computing device 38 (e.g., a cell phone or tablet with an embedded touchscreen).

Processing circuitry 40 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 42 may include one or more Ethernet cards, cellular modems, Fibre Channel (FC) adapters, InfiniB and adapters, wireless networking adapters (e.g., Wi-Fi), and/or other devices for connecting to network 37.

Memory 50 may include any kind of digital system memory, such as, for example, random access memory (RAM), read-only memory (ROM), one-time programmable (OTP) memory, and/or flash memory. Memory 50 stores an operating system (OS, e.g., a Linux, UNIX, Windows, MacOS, or similar operating system) and various drivers and other applications and software modules configured to execute on processing circuitry 40.

In some embodiments, memory 50 of client computing device 34 stores a client-side configuration application (CCA) 53, which is configured to execute on processing circuitry 40 of computing device 38 to interface between the user 39 operating UI devices 46, 48 and a flexible configuration application (FCA) 52 running on NMC 34 (or, in some embodiments, on an external web server). In some embodiments, CCA 53 may be downloaded from NMC 34 (or the external web server). In some embodiments, memory 50 of client computing device 34 may include a web browser (not depicted) configured to display web pages served by NMC 34 (or the external web server). In some embodiments, CCA 53 may be a single-page application (SPA) (e.g., using the Angular or AngularJS framework) configured to dynamically rewrite a web page based on user input without need to download entire web pages in response to user input. In other embodiments, CCA 53 may be an application (e.g., written in Java or Elixir) that runs on a local virtual machine (e.g., JVM or BEAM).

In operation, CCA 53 (or the web browser) causes computing device 38 to display a flexible configuration application window 60 on display 48. User 39 may then enter credentials into flexible configuration application window 60 to be sent to NMC 34 (or the external web server) for use in the configuration of the NMC 34 for authentication for operation on the network 37. In some embodiments, CCA 53 may also perform additional functions, such as, for example, allowing the user 39 to view and/or alter configuration settings and performance of the UPS 32.

Processing circuitry 40 and memory 50 of NMC 34 (or the external web server) may be similar as on computing device 38. Memory 50 of NMC 34 (or the external web server) includes software for receiving and validating a completed set of credentials from computing device 38 and for serving as an EAPoL supplicant in order to request authentication from EAPoL authenticator device 70 using the credentials. This software includes FSA 52, which may include a validation module 80 and an EAPoL supplication module 82. In the event of an external web server being used, EAPoL supplication module 82 runs on the NMC 34 rather than on the external web server.

In operation, when user 39 wants to configure NMC 34 to authenticate to communicate over network 37, user 39 launches CCA 53 or its local web browser to initiate a session with FCA 52. In some embodiments, the web browser may operate to download code for the CCA 53 from FCA 52. FCA 52 sends a set of request pages 54 (depicted as first request page 54(1), second request page 54(2), third request page 54(3), last request page 54(4)) in a particular order to CCA 53 or the web browser, which launches FCA window 60 on display 48 and displays the request pages 54 in that order. Although four request pages 54(1)-54(4) have been depicted, in other embodiments, another number of request pages 54 may be used.

In one example embodiment, as depicted, first request page 54(1) serves to request and obtain a certificate authority (CA) certificate 56, second request page 54(2) serves to request and obtain a private key 57, third request page 54(3) serves to request and obtain a passphrase 58 that is associated with the private key 57, and last request page 54(4) serves to request and obtain a user certificate 59.

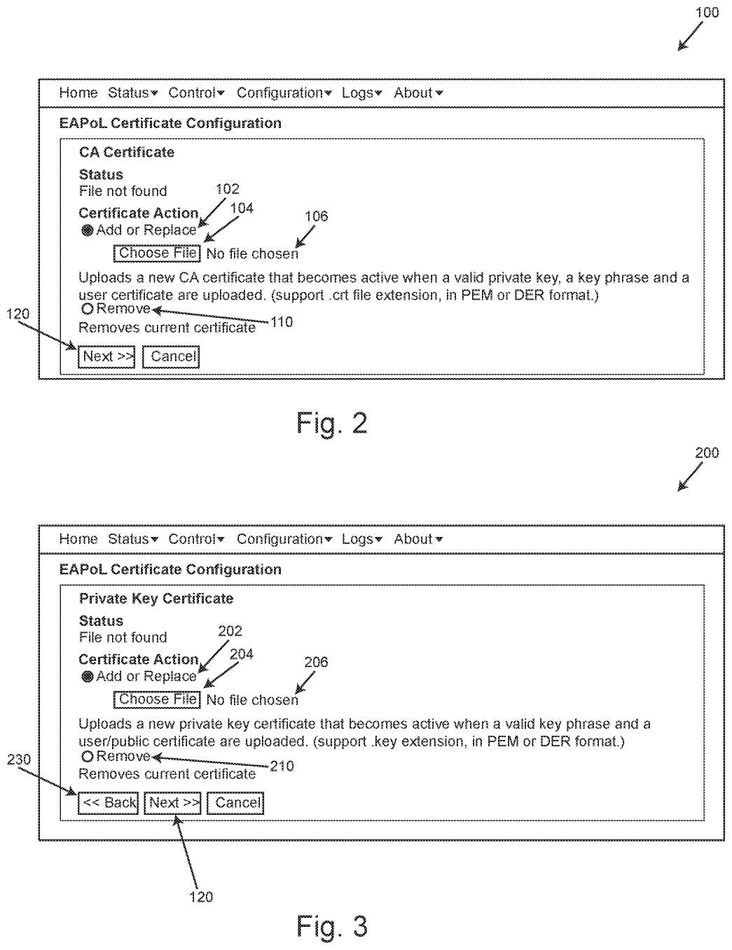

FIG. 2 depicts an example screen 100 that may function as first request page 54(1) to request and obtain a certificate authority (CA) certificate 56 from the user 39. Screen 100 includes an instruction selection 102 which the user 39 can choose to add a (or replace a previously added) CA certificate 56. Screen 100 also includes an instruction selection 110 which the user 39 can choose to remove a previously added CA certificate 56. As depicted, instruction selections 102, 110 may be implemented as radio boxes. In connection with instruction selection 102, screen 100 may also include a description 106 of a previously-added CA certificate 56 (as depicted, description 106 indicates that no CA certificate 56 has yet been added, or, if one was previously added, it has since been removed). In connection with instruction selection 102, screen 100 may also include a control element 104 that launches a dialog box (or another similar control element) that allows user 39 to enter a new CA certificate 56. In some embodiments, the user 39 browses and selects a file already stored on computing device 38 that includes the CA certificate 56 encoded in text format (e.g., PEM) or binary format (e.g., DER). Screen 100 also includes a completion control element 120 that allows the user 39 to proceed to the next screen 54(2). If the completion control element 120 is selected without having first added a new CA certificate 56 (e.g., via the dialog box launched by selecting control element 104) or removed a previously added CA certificate 56 (e.g., via the instruction selection 110), then user 39 has effectively bypassed screen 54(1) without having taken any action.

FIG. 3 depicts an example screen 200 that may function as second request page 54(2) to request and obtain a private key 57 from the user 39. Screen 200 includes an instruction selection 202 which the user 39 can choose to add a (or replace a previously added) private key 57. Screen 200 also includes an instruction selection 210 which the user 39 can choose to remove a previously added private key 57. As depicted, instruction selections 202, 210 may be implemented as radio boxes. In connection with instruction selection 202, screen 200 may also include a description 206 of a previously-added private key 57 (as depicted, description 206 indicates that no private key 57 has yet been added, or, if one was previously added, it has since been removed). In connection with instruction selection 202, screen 200 may also include a control element 204 that launches a dialog box (or another similar control element) that allows user 39 to enter a new private key 57. In some embodiments, the user 39 browses and selects a file already stored on computing device 38 that includes the private key 57 encoded in text format (e.g., PEM) or binary format (e.g., DER). Screen 200 also includes a completion control element 120 that allows the user 39 to proceed to the next screen 54(3). If the completion control element 120 is selected without having first added a new private key 57 (e.g., via the dialog box launched by selecting control element 204) or removed a previously added private key 57 (e.g., via the instruction selection 210), then user 39 has effectively bypassed screen 54(2) without having taken any action. Screen 200 also includes a back control element 230 that allows the user 39 to return to the previous screen 54(1).

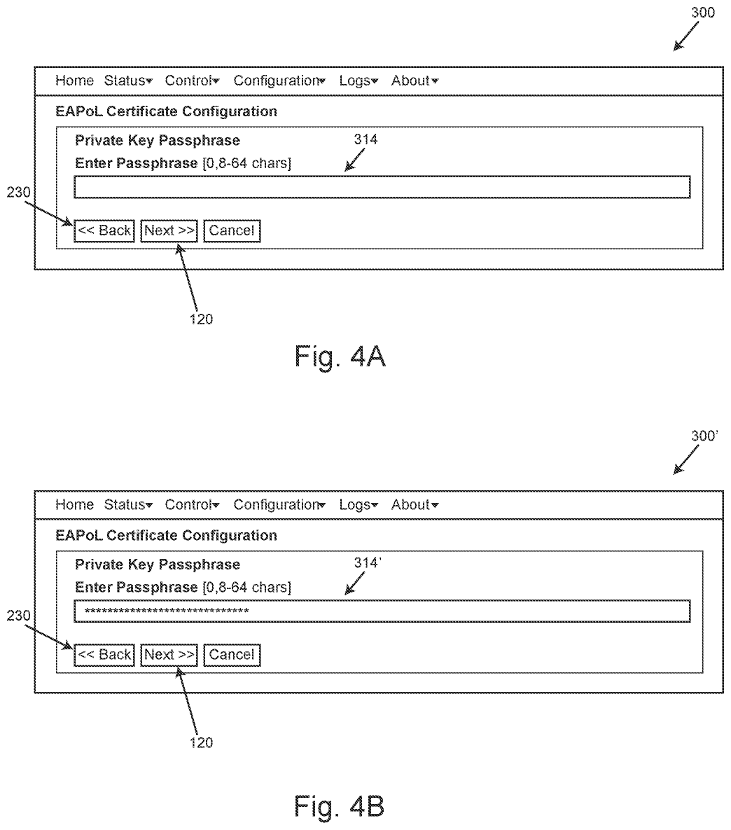

FIG. 4A depicts an example screen 300 that may function as third request page 54(3) to request and obtain a passphrase 58 associated with the private key 57 from the user 39. Screen 300 includes an empty text entry field 314, indicating that no passphrase 58 has yet been added (or, if one was previously added, it has since been removed). The user 39 is able to type a new passphrase 58 into field 314. FIG. 4B depicts an alternative example screen 300′ that may function as third request page 54(3) in the event that a passphrase 58 has previously been entered. Alternative example screen 300′ includes a text entry field 314′ that includes stars or dots, indicating that a passphrase 58 has previously been added. The user 39 is able to delete the previously added passphrase 58 or type a new passphrase 58 into field 314′. Screens 300, 300′ also include a completion control element 120 that allows the user 39 to proceed to the next screen 54(4). If the completion control element 120 is selected without having first added a new passphrase 58 into entry field 314, 314′ or removed a previously added passphrase 58 from entry field 314′, then user 39 has effectively bypassed screen 54(3) without having taken any action. Screens 300, 300′ also include a back control element 230 that allows the user 39 to return to the previous screen 54(1). It should be understood that, in some embodiments, the passphrase 58 is entirely optional; if no passphrase 58 is entered or if a previously-entered passphrase 58 is removed, then it may be possible to configure the NMC 34 without any passphrase 58.

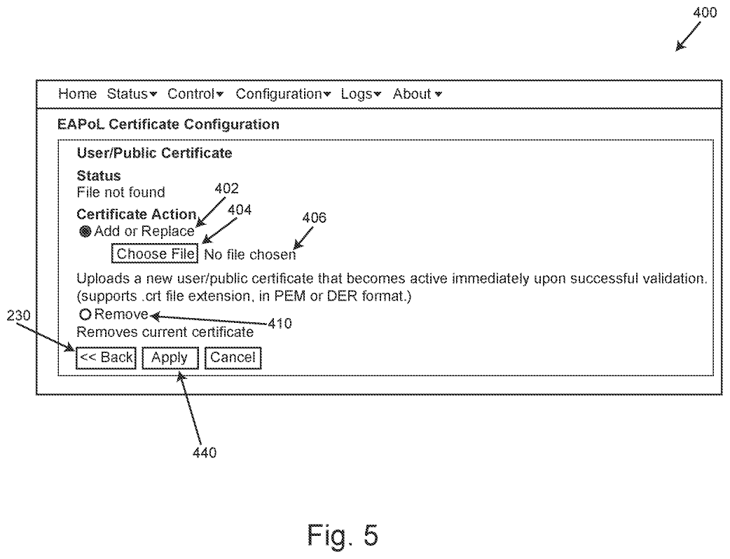

FIG. 5 depicts an example screen 400 that may function as last request page 54(4) to request and obtain a user certificate 59 from the user 39. Screen 400 includes an instruction selection 402 which the user 39 can choose to add a (or replace a previously added) user certificate 59. Screen 400 also includes an instruction selection 410 which the user 39 can choose to remove a previously added user certificate 59. As depicted, instruction selections 402, 410 may be implemented as radio boxes. In connection with instruction selection 402, screen 400 may also include a description 406 of a previously-added user certificate 59 (as depicted, description 406 indicates that no user certificate 59 has yet been added, or, if one was previously added, it has since been removed). In connection with instruction selection 402, screen 400 may also include a control element 404 that launches a dialog box (or another similar control element) that allows user 39 to enter a new user certificate 59. In some embodiments, the user 39 browses and selects a file already stored on computing device 38 that includes the user certificate 59 encoded in text format (e.g., PEM) or binary format (e.g., DER). Screen 400 also includes an Apply element 440 that allows the user 39 to upload all items (e.g., one or more of 56, 57, 58, 59) that were added to the NMC 34 (or the external web server) so that EAPoL supplication module 82 can submit the credentials 56, 57, 58, 59 to the EAPoL authenticator device 70 for configuration of the NMC 34 for authentication after validation by validation module 80. Screen 400 also includes a back control element 230 that allows the user 39 to return to the previous screen 54(3). If the back control element 230 is selected without having first added a new user certificate 59 (e.g., via the dialog box launched by selecting control element 404) or removed a previously added user certificate 59 (e.g., via the instruction selection 410), then user 39 has effectively bypassed screen 54(4) without having taken any action.

Memory 50 of the computing device 38 may also store various other data structures used by the OS, CCA 53 and various other applications and drivers. Memory 50 of the NMC 34 (or the external web server) may also store various other data structures used by the OS, FCA 52, validation module 80, EAPoL supplication module 82, and various other applications and drivers.

In some embodiments, memory 50 may also include a persistent storage portion. Persistent storage portion of memory 50 may be made up of one or more persistent storage devices, such as, for example, magnetic disks, flash drives, solid-state storage drives, or other types of storage drives. Persistent storage portion of memory 50 is configured to store programs and data even while the computing device 38 is powered off. The OS, FCA 52, CCA 53, validation module 80, EAPoL supplication module 82 and/or various other applications and drivers may be stored in this persistent storage portion of memory 50 so that they may be loaded into a system portion of memory 50 upon a system restart or as needed. The OS, FCA 52, CCA 53, validation module 80, EAPoL supplication module 82 and various other applications and drivers, when stored in non-transitory form either in the volatile or persistent portion of memory 50, each form a computer program product. The processing circuitry 40 running one or more applications thus forms a specialized circuit constructed and arranged to carry out the various processes described herein.

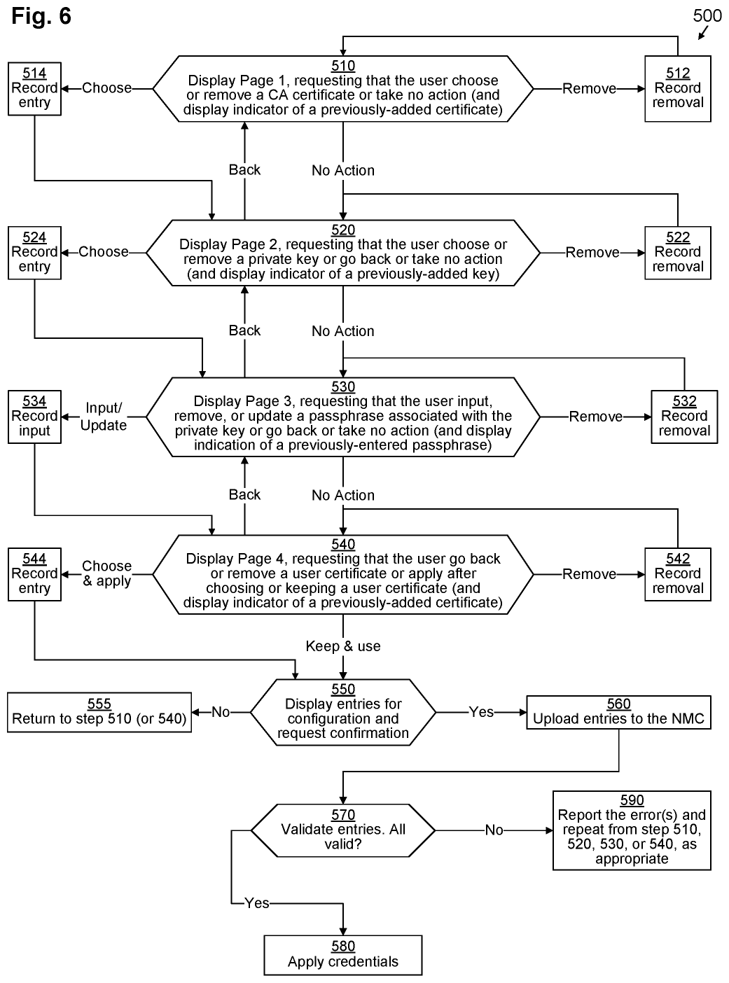

FIG. 6 illustrates an example method 100 performed by a system 30 for configuring the NMC 34 for authentication in a flexible manner. It should be understood that any time a piece of software (e.g., OS, FCA 52, CCA 53, validation module 80, EAPoL supplication module 82, etc.) is described as performing a method, process, step, or function, what is meant is that a computing device (e.g., computing device 38, NMC 34, EAPoL authenticator device 70, authentication server 71, external web server, etc.) on which that piece of software is running performs the method, process, step, or function when executing that piece of software on its processing circuitry 40. It should be understood, that one or more of the steps or sub-steps of method 100 may be omitted in some embodiments. Similarly, in some embodiments, one or more steps or sub-steps may be combined or performed in a different order. Dashed lines indicate that a step or sub-step is either optional or representative of alternate embodiments or use cases.

In step 510, FCA 52 sends a first request page 54(1) (e.g., screen 100) to CCA 53 or web browser running on computing device 38 to be displayed in FCA window 60, the first request page 54(1) requesting that the user 39 select or remove a CA certificate 56 or take no action. In some embodiments, step 510 includes displaying a description 106 of a previously-added CA certificate 56, if any. If the user 39 chooses to select a CA certificate 56 (e.g., by selecting control element 104 to launch a dialog box that allows the user 39 to select a file containing the CA certificate 56 and then selecting the completion control element 120 while the radio box for the instruction selection 102 is checked), then operation proceeds with step 514, in which CCA 53 records the selected CA certificate 56 for later upload. If the user 39 chooses to remove a previously-added CA certificate 56 (e.g., by selecting the completion control element 120 while the radio box for the instruction selection 110 is checked), then operation proceeds with step 512, in which CCA 53 records removal of the previously-selected CA certificate 56, after which operation returns back to step 510. If the user 39 takes no action (e.g., by selecting the completion control element 120 while the radio box for the instruction selection 102 is checked without having selected control element 104 to select a file containing the CA certificate 56), then operation proceeds to step 520. Operation also proceeds to step 520 after step 514.

In step 520, FCA 52 sends a second request page 54(2) (e.g., screen 200) to CCA 53 or web browser running on computing device 38 to be displayed in FCA window 60, the second request page 54(2) requesting that the user 39 select or remove a private key 57 or go back or take no action. In some embodiments, step 520 includes displaying a description 206 of a previously-added private key 57, if any. If the user 39 chooses to select a private key 57 (e.g., by selecting control element 204 to launch a dialog box that allows the user 39 to select a file containing the private key 57 and then selecting the completion control element 120 while the radio box for the instruction selection 202 is checked), then operation proceeds with step 524, in which CCA 53 records the selected private key 57 for later upload. If the user 39 chooses to remove a previously-added private key 57 (e.g., by selecting the completion control element 120 while the radio box for the instruction selection 210 is checked), then operation proceeds with step 522, in which CCA 53 records removal of the previously-selected private key 57, after which operation returns back to step 520. If the user 39 takes no action (e.g., by selecting the completion control element 120 while the radio box for the instruction selection 202 is checked without having selected control element 204 to select a file containing the private key 57), then operation proceeds to step 530. Operation also proceeds to step 530 after step 524. If the user 39 chooses to go back (e.g., by selecting back control element 230), then operation returns back to step 510.

In step 530, FCA 52 sends a third request page (e.g., screen 300, 300′) to CCA 53 or web browser running on computing device 38 to be displayed in FCA window 60, the third request page 54(3) requesting that the user 39 input (or remove or update, in the case of screen 300′) a passphrase 58 associated with the private key 57 or go back or take no action. In some embodiments, when a passphrase 58 has previously been entered, FCA 52 displays stars, dots, or other placeholder characters in text entry field 314′ to indicate that the passphrase 58 was previously entered without revealing the contents of that passphrase 58. If the user 39 chooses to input the passphrase 59 (e.g., by typing anything into text entry field 314 and then selecting the completion control element 120) or update the passphrase 59 (e.g., by deleting any of the star characters and also typing anything into text entry field 314′ and then selecting the completion control element 120), then operation proceeds with step 534, in which CCA 53 records the inputted passphrase 58 for later upload. If the user 39 chooses to remove the passphrase (e.g., if all stars are removed from text entry field 314′ and nothing else is typed in in their place), then operation proceeds with step 532, in which CCA 53 records removal of the previously-entered passphrase 58, after which operation returns back to step 530. If the user 39 takes no action (e.g., by selecting the completion control element 120 without making any changes to text entry field 314, 314′), then operation proceeds to step 540. Operation also proceeds to step 540 after step 534. If the user 39 chooses to go back (e.g., by selecting back control element 230), then operation returns back to step 520.

In step 540, FCA 52 sends a last request page 54(4) (e.g., screen 400) to CCA 53 or web browser running on computing device 38 to be displayed in FCA window 60, the last request page 54(4) requesting that the user 39 go back or remove a user certificate 59 or apply all changes after adding or keeping a user certificate 59. In some embodiments, step 540 includes displaying a description 406 of a previously-added user certificate 59, if any. If the user 39 chooses to select and apply a user certificate 59 (e.g., by selecting control element 404 to launch a dialog box that allows the user 39 to select a file containing the user certificate 59 and then selecting the Apply element 440 while the radio box for the instruction selection 402 is checked), then operation proceeds with step 544, in which CCA 53 records the selected user certificate 59 for upload, followed by step 550. If the user 39 chooses to remove a previously-added user certificate 59 (e.g., by selecting the Apply element 44 while the radio box for the instruction selection 410 is checked), then operation proceeds with step 542, in which CCA 53 records removal of the previously-selected user certificate 59, after which operation returns back to step 540. If the user 39 applies with no other action (e.g., by selecting the Apply element 440 while the radio box for the instruction selection 402 is checked without having selected control element 404 to select a file containing the user certificate 59), then operation proceeds to step 550. If the user 39 chooses to go back (e.g., by selecting back control element 230), then operation returns back to step 530.

In some embodiments (not depicted), prior to step 550 or 560, CCA 53 performs a preliminary validation of the credentials 56, 57, 58, 59 prior to uploading them to the NMC 34 (or to the external web server). In one embodiment, CCA 53 checks to make sure that the CA certificate 56 and the user certificate 59 both have a “.crt” file extension and that private key 57 has a “.key” file extension. In one embodiment, CCA 53 also checks to make sure that if the passphrase 58 has been entered it is in a proper format (e.g., it is between 8 and 64 characters long with at least 1 number and 1 letter). If the validation fails, then the reason is retained and operation proceeds to step 590; otherwise, operation proceeds on to step 550.

In step 550, FCA 52 causes CCA 52 or the web browser to display a confirmation message on FCA screen 60, including a list of the credentials 56, 57, 58, 59 to be used for the configuration, requesting that the user 39 confirm whether or not to proceed. If the user 39 cancels, then operation proceeds with step 555, in which operation goes back to either 510 or 540, depending on the embodiment. If the user 39 selects to proceed, then, after step 550, operation proceeds with step 560.

In step 560, CCA 53 or the web browser uploads the credentials 56, 57, 58, 59 to the NMC 34 (or the external web server). In some embodiments, step 560 may be performed using REpresentational State Transfer (REST).

Then, in step 570, validation module 80 of FCA 52 checks to make sure that at least the CA certificate 56, the private key 57, and the user certificate 59 have all been added (keeping in mind that one or more of the CA certificate 56, the private key 57, and the user certificate 59 could have been previously added in a previous upload operation, which will validate properly as long as it was not removed without being replaced). In one embodiment, FCA 52 checks to make sure that all of the CA certificate 56, the private key 57, and the user certificate 59 are in a proper format (e.g., PEM or DER format and having the proper length). In some embodiments, FCA 52 also checks to make sure that the passphrase 58 has been entered and/or that it is in a proper format (e.g., it is between 8 and 64 characters long with at least 1 number and 1 letter) if it has been entered. In some embodiments, FCA 52 checks to make sure that the passphrase 58 is consistent with the private key 57. In some embodiments, FCA 52 checks to make sure that the CA certificate 56 and the user certificate 59 both have a “.crt” file extension and that private key 57 has a “.key” file extension. If the validation fails, then the reason is retained and operation proceeds to step 590; otherwise, operation proceeds to step 580.

In step 580, FCA 52 applies the credentials 56, 57, (58) 59 to the NMC 34 so that EAPoL Supplication Module 82 can enter a supplication mode so that it can attempt to authenticate the NMC 34 via the EAPoL authenticator device 70 using the credentials 56, 57, (58,) 59 to receive authorization to operate on network 37 through the EAPoL authenticator device 70. EAPoL authenticator device 70 uses the received credentials 56, 57, (58,) 59 to perform authentication with authentication server 71, e.g., a RADIUS server. This authentication and authorization process may wait until EAPoL authenticator device 70 queries the NMC 34 for the credentials 56, 57, (58,) 59. If an external web server is used, then the external web server sends the received credentials 56, 57, (58,) 59 to the NMC 34 as part of step 580.

In step 590, FCA 52 causes CCA 52 or the web browser to report the reason(s) for the failure to validate to the user 39 via FCA screen 60, after which operation proceeds with step 510, 520, 530, or 540, depending which of the credentials 56, 57, 58, 59 is defective.

It should be understood that although steps 510, 520, 530, 540 have been described as FCA 52 sequentially sending request pages 54 to computing device 38, that is by way of example only. In some embodiments, FCA 52 sends complete CCA 53 to computing device 38 initially, complete CCA 53 being configured to navigate between request pages 54 based on input from the user 39. In other embodiments, FCA 52 sends CCA 53 to computing device 38 initially, CCA 53 being configured retrieve instructions from FCA 52 about how to display the various request pages 54 or how to modify the FCA window 60 to create the various request pages 54 on the fly based on input from the user 39.

Thus, a configuration tool that allows a user to configure the NMC 34 for authentication using EAPoL in a flexible manner has been described. The user 39 is provided with a set of configuration pages 54 in a predetermined order, while also being permitted to skip input for particular configuration pages 54 for which information has already been entered. In some embodiments, the user 39 may also be permitted to navigate back to previously presented configuration pages 54 to enter information out of order. Final validation and submission of the credentials 56-59 may be done once the user 39 is ready to submit all credentials. In addition, previously-entered credentials 56-59 may be retained from a previous configuration attempt, so that the user 39 need not enter all credentials 56-59 unless there is a change to that credential 56-59. Beneficially, the configuration of the NMC 34 changes but not all of the credentials 56-59 change; the user 39 need not re-enter all of the credentials 56-59. In addition, the user 39 is able to enter the credentials 56-59 as they become available, while skipping credentials 56-59 that are not yet available until later.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102, such determination being a legal determination that depends upon many factors, not all of which are known to Applicants at this time.

What is claimed is:

1. A computer program product comprising a non-transitory computer-readable storage medium storing a set of instructions, which, when executed by a computing device, causes the computing device to configure a network management card to be able to perform an authentication and authorization process by:
outputting a set of data input pages in an order, wherein the set of data input pages is configured to receive:
information identifying a first certificate from a certifying authority,
information identifying a private key,
a passphrase associated with the private key, and
information identifying a second certificate from a user;
permitting receiving information on pages of the set out of the order; and
in response to the user completing a last page of the set, applying changes inputted by the user via the set of data input pages to configure the network management card to be able to perform the authentication and authorization process.

2. The computer program product of claim 1 wherein outputting the set of data input pages in the order includes:
causing a first data input page to be displayed to the user, the first data input page being configured to receive the information identifying the first certificate from the certifying authority;
causing a second data input page to be displayed to the user, the second data input page being configured to receive the information identifying the private key;
causing a third data input page to be displayed to the user, the third data input page being configured to receive the passphrase associated with the private key; and
causing a fourth data input page to be displayed to the user, the fourth data input page being configured to receive the information identifying the second certificate from the user.

3. The computer program product of claim 1 wherein permitting receiving information on pages of the set out of the order includes:
allowing the user to skip input on any of the data input pages; and
allowing the user to return to any previously displayed data input page.

4. The computer program product of claim 1, wherein applying changes inputted by the user via the set of data input pages to configure the network management card to be able to perform the authentication and authorization process includes requesting authentication from a remote authentication device with reference to the first certificate, the private key, and the second certificate.

5. The computer program product of claim 4 wherein the instructions, when executed by the computing device further cause the computing device to, prior to applying the changes inputted by the user, validate the changes inputted by the user.

6. The computer program product of claim 5 wherein the instructions, when executed by the computing device further cause the computing device to, in response to failure to validate the changes inputted by the user and prior to applying the changes inputted by the user:
inform the user what errors led to the failure to validate the changes; and
output one or more pages of the set of data input pages again in the order.

7. The computer program product of claim 5 wherein validating the changes inputted by the user includes:
confirming that a valid first certificate from the certifying authority has either been received from a remote user device or is already stored on the computing device;
confirming, by the network management card, that a valid private key has either been received from the remote user device or is already stored on the computing device; and
confirming, by the network management card, that a valid second certificate from the user has either been received from the remote user device or is already stored on the computing device.

8. The computer program product of claim 7 wherein validating the changes inputted by the user further includes confirming that a valid passphrase associated with the private key has either been received from the remote user device or is already stored on the computing device.

9. The computer program product of claim 5 wherein validating the changes inputted by the user includes:
confirming that the first certificate and second certificate are both formatted according to a first format consistent with a standard used for certificates; and
confirming that the private key is formatted according to a second format consistent with a standard used for keys.

10. The computer program product of claim 4 wherein requesting authentication from the remote authentication device is further performed with reference to the passphrase associated with the private key.

11. An apparatus for remotely configuring a network management card to be able to perform an authentication and authorization process, the apparatus comprising:
a network interface configured to communicate with a user device over a network; and
processing circuitry configured to:
output a set of data input pages to the user device over the network in an order, wherein the set of data input pages is configured to receive:
information identifying a first certificate from a certifying authority,
information identifying a private key,
a passphrase associated with the private key, and
information identifying a second certificate from a user;
permit receiving information on pages of the set out of the order; and
in response to the user completing a last page of the set, applying changes inputted by the user via the set of data input pages to configure the network management card to be able to perform the authentication and authorization process.

12. The apparatus of claim 11, wherein outputting the set of data input pages in the order includes:
causing a first data input page to be displayed to the user, the first data input page being configured to receive, at the user device, the information identifying the first certificate from the certifying authority;
causing a second data input page to be displayed to the user, the second data input page being configured to receive, at the user device, the information identifying the private key;
causing a third data input page to be displayed to the user, the third data input page being configured to receive, at the user device, the passphrase associated with the private key; and
causing a fourth data input page to be displayed to the user, the fourth data input page being configured to receive, at the user device, the information identifying the second certificate from the user.

13. The apparatus of claim 11 wherein permitting receiving information on pages of the set out of the order includes:
allowing the user to skip input on any of the data input pages; and
allowing the user to return to any previously displayed data input page.

14. The apparatus of claim 11, wherein applying changes inputted by the user via the set of data input pages to configure the network management card to be able to perform the authentication and authorization process includes requesting authentication from a remote authentication device with reference to the first certificate, the private key, and the second certificate.

15. The apparatus of claim 14 wherein the processing circuitry is further configured to, prior to applying the changes inputted by the user, validate the changes inputted by the user.

16. The apparatus of claim 15 wherein the processing circuitry is further configured to, in response to failure to validate the changes inputted by the user and prior to applying the changes inputted by the user:
inform the user what errors led to the failure to validate the changes; and
output one or more pages of the set of data input pages to the user device over the network again in the order.

17. The apparatus of claim 15 wherein validating the changes inputted by the user includes:
confirming that a valid first certificate from the certifying authority has either been received from the user device or is already stored on the apparatus;
confirming, by the network management card, that a valid private key has either been received from the user device or is already stored on the apparatus; and
confirming, by the network management card, that a valid second certificate from the user has either been received from the user device or is already stored on the apparatus.

18. The apparatus of claim 17 wherein validating the changes inputted by the user further includes confirming that a valid passphrase associated with the private key has either been received from the user device or is already stored on the apparatus.

19. The apparatus of claim 11 wherein the apparatus is the network management card.

20. A method performed by a computing device for remotely configuring a network management card to be able to perform an authentication and authorization process, the method comprising:
outputting a set of data input pages in an order, wherein the set of data input pages is configured to receive:
information identifying a first certificate from a certifying authority,
information identifying a private key,
a passphrase associated with the private key, and
information identifying a second certificate from a user;
permitting receiving information on pages of the set out of the order; and
in response to the user completing a last page of the set, applying changes inputted by the user via the set of data input pages to configure the network management card to be able to perform the authentication and authorization process.
